(19) United States
(12) Patent Application Publication
(10) Pub. No.: US 2025/0173795 A1
(43) Pub. Date: May 29, 2025

(54) METHOD TO MEASURE INSURABILITY BASED ON RELATIVE OPERATOR PERFORMANCE

(71) Applicant: GM Global Technology Operations LLC, Detroit, MI (US)

(72) Inventors: Donald K. Grimm, Utica, MI (US); Fan Bai, Ann Arbor, MI (US); Omer Tsimhoni, Bloomfield Hills, MI (US); Jingyan Wan, Sterling Heights, MI (US); Andrew Rose, Glen Allen, VA (US)

(21) Appl. No.: 18/521,198

(22) Filed: Nov. 28, 2023

(51) Int. Cl. G06Q 40/08; G07C 5/00; G08G 1/01

(52) U.S. Cl. CPC G06Q 40/08; G07C 5/008; G08G 1/0133

(57) ABSTRACT

A system for measuring insurability based on relative vehicle operator performance (MIROP) includes sensors capturing host and remote vehicle information, and information about an environment of the host and remote vehicles. A controller executes a MIROP application that identifies event information within data obtained from the sensors, transmits, the event information to a cloud computing server, assesses a physical location and proximity of the host vehicle to remote vehicles participating in the system. The MIROP application assesses a road surface condition of a road segment upon which the host vehicle is traveling, estimates a traffic density on the road segment, aggregates host vehicle behavioral data and identifies event IDs within the behavioral data. The MIROP application computes a vehicle operator insurability score and automatically notifies an insurance carrier of the score as well as automatically presenting the score and suggestions to improve the score to a host vehicle operator.

### INTRODUCTION

The present disclosure relates to systems and methods for measuring insurability of vehicle operators, and more specifically to systems and methods for assessing vehicle operator performance in a context-oriented manner.

Current systems and methods for measuring the insurability of vehicle operators rely upon absolute measures, such as hard braking or acceleration without reference to the context in which the absolutely-measured events occur. Thus, current vehicle operators may be penalized for executing safe maneuvers, even when the maneuvers are required by driving context, or design of the environment.

Accordingly, while current systems and methods for determining insurability of vehicle operators achieve their intended purpose, there is a need for new and improved systems and methods for measuring insurability based on relative vehicle operator performance that provide high fidelity estimates of vehicle operator performance based on how a vehicle operator behaves compared to other vehicle operators at substantially the same time and at substantially the same geographical location, and which score behavior based on relative deviation from behavioral norms to accurately assess vehicle operator risk based on context, while minimizing false positives due to road design, and accurately assess vehicle operator skill all while operating on existing hardware and utilizing existing systems, while maintaining or decreasing complexity.

### SUMMARY

According to several aspects of the present disclosure a system for measuring insurability based on relative vehicle operator performance includes a host vehicle, and one or more remote vehicles. One or more sensors capture host vehicle and remote vehicle information, and capture environmental information about an environment of the host vehicle and the one or more remote vehicles. The system further includes a cloud computing server in communication with the host vehicle and the one or more remote vehicles. Each of the host vehicle, the one or more remote vehicles, and the cloud computing server has a controller. The controllers each include a processor, a memory, and one or more input/output (I/O) ports. The I/O ports are in communication with the one or more sensors. The memory stores programmatic control logic. The processor executes the programmatic control logic. The programmatic control logic includes an application for measuring insurability based on relative vehicle operator performance (MIROP application). The MIROP application includes at least first, second, third, fourth, fifth, sixth, seventh, eighth, and ninth control logics. The first control logic identifies event information within data obtained from the one or more sensors. The second control logic transmits, via the I/O ports of the controller of one or more of the host vehicle and the I/O ports of the one or more remote vehicles, the event information to the cloud computing server. The third control logic assesses a physical location and proximity of the host vehicle to remote vehicles participating in the system. The fourth control logic assesses a road surface condition of a road segment upon which the host vehicle is traveling. The fifth control logic estimates a traffic density on the road segment. The sixth control logic aggregates host vehicle behavioral data and identifying event IDs within the host vehicle behavioral data. The seventh control logic computes a vehicle operator insurability score. The eighth control logic automatically notifies an insurance carrier of the vehicle operator insurability score. The ninth control logic automatically presents to a host vehicle operator, via a human-machine interface (HMI), score information and vehicle operation suggestions to improve the vehicle operator insurability score.

In another aspect of the present disclosure the first control logic further includes control logic for detecting event information including: instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy.

In yet another aspect of the present disclosure, the first control logic further includes: control logic for comparing instances of host vehicle and/or remote vehicle hard braking, hard acceleration, and hard cornering to threshold acceleration, braking, and cornering values; and control logic that executes the second control logic to periodically transmit event information, relating to the instances of host vehicle and/or remote vehicle hard braking, hard acceleration and hard cornering that meet or exceed the threshold acceleration, braking, and cornering values, to the cloud computing server.

In yet another aspect of the present disclosure the third control logic further includes control logic for confirming a location of the host vehicle relative to map information stored in a map database, control logic for determining a location of the one or more remote vehicles relative to map information stored in the map database; and control logic for determining that one or more of the remote vehicles is at or below a threshold physical distance of the host vehicle, or that one or more of the remote vehicles has traversed the road segment at or within a threshold quantity of time relative to the host vehicle.

In yet another aspect of the present disclosure the fourth control logic further includes: control logic for utilizing data from the one or more sensors to estimate a road surface type, a road surface condition, a presence or absence of obstacles on the road segment, a location of lane markings on the road segment, and control logic for obtaining information from one or more application programming interfaces (APIs) including a weather API. The weather API provides weather information for the environment surrounding the host vehicle on the road segment.

In yet another aspect of the present disclosure the fifth control logic further includes: control logic for obtaining information from one or more application programming interfaces (APIs) including one or more traffic APIs. The traffic APIs report, to the host vehicle, current and historical traffic information about the road segment. The fifth control logic further includes control logic that utilizes data from the traffic API and from the one or more sensors to estimate a traffic density including traffic signal status at approximately a one second accuracy, and that determines when the host vehicle is approaching or passing through a traffic signal.

In yet another aspect of the present disclosure the sixth control logic further includes control logic for identifying event IDs corresponding to instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy. The sixth control logic further includes control logic for determining when one or more remote vehicle perspectives is available. Upon determining that one or more remote vehicle perspectives is available the sixth control logic utilizes the remote vehicle perspectives to provide context to behavior of the host vehicle. The sixth control logic further includes control logic for accessing a road profile database that includes physical characteristics of the road segment, and contextual information, including traffic data, time of day information, and road surface information relating to the road segment.

In yet another aspect of the present disclosure the seventh control logic further includes: control logic for calculating first order vehicle operator driving characteristics, control logic for calculating a derived time series for vehicle operator driving parameters of interest; and control logic for applying weighting factors to each to determine a relative performance of the vehicle operator in comparison with similarly-situated remote vehicle operators in similar contexts over the road segment or similar road segments.

In yet another aspect of the present disclosure the seventh control logic further includes control logic for calculating aggressiveness x(t), via sudden acceleration a(t) and close following distances b(t), and control logic for calculating an average aggressiveness according to:

$$( {p}_{1}^{i} ) : {\overline{x}}_{ι} = {\sum }_{t = 1}^{T} \frac{{x}_{i} ( t )}{T} ; \qquad II .$$

control logic for calculating a standard deviation in aggressiveness according to:

$$( {p}_{2}^{i} ) : {\tilde{x}}_{ι} = \sqrt{{\sum }_{t = 1}^{T} \frac{( {x}_{i} ( c ) - \overline{x} )}{T - 1}} ; \qquad III .$$

and control logic for calculating a vehicle operator aggressiveness trend over time according to:

$$( {p}_{a}^{i} ) : {\hat{β}}_{ι} = \frac{{\sum }_{i = 0}^{n} ( {x}_{i} - \overline{x} ) ( {Y}_{i} - \overline{y} )}{{\sum }_{i = 0}^{n} {( {x}_{i} - \overline{x} )}^{2}} > 0 ; \qquad IV .$$

where (xᵢ−x̅)² is a normalizing characteristic, and \hat{β}_{ι} indicates whether the vehicle 12, 12′ operator is becoming more, less, or equally aggressive over a predefined quantity of time. The seventh control logic further includes: control logic for calculating a cumulative distribution function (CDF) that ranks all participating host and remote vehicle operator performance according to:

$${\sum }_{i = 0}^{n} {w}_{i} * rank ( {a}_{1} , {Q}_{1} ) ; \qquad I .$$

where each aₙ defines a characteristic of a particular event Qₙ on a per-vehicle n basis, and wᵢ defines the weighting factors.

In yet another aspect of the present disclosure the eighth control logic further includes control logic for notifying an insurance carrier of the vehicle operator insurability score based on one or more of: a predetermined time schedule, a quantity of distance traveled by the host vehicle operator, identified behavioral changes, host vehicle location changes, and host vehicle commute pattern changes.

In yet another aspect of the present disclosure the ninth control logic further includes: control logic for presenting the operator score information and vehicle operation suggestions on one or more of: an infotainment display of the host vehicle, an instrument cluster of the host vehicle, an interior rear-view screen of the host vehicle, a cellular device, a laptop computer, and a tablet computer. The vehicle operation suggestions include: score improvement advice, driving behavior improvement suggestions, driving route modification suggestions, and host vehicle mode selection suggestions.

In several additional aspects of the present disclosure, a method for measuring insurability based on relative vehicle operator performance includes capturing, via one or more sensors, information about a host vehicle and one or more remote vehicles, and capturing environmental information about an environment surrounding the host vehicle and the one or more remote vehicles. The method further includes utilizing a cloud computing server in communication with the host vehicle and the one or more remote vehicles, and utilizing one or more controllers disposed in each of the host vehicle, the one or more remote vehicles, and the cloud computing server, the controllers each including a processor, a memory, and one or more input/output (I/O) ports, the I/O ports in communication with the one or more sensors; the memory storing programmatic control logic; the processor executing the programmatic control logic. The method further includes utilizing the controller to execute programmatic control logic including an application for measuring insurability based on relative vehicle operator performance (MIROP application). The MIROP application includes: identifying event information within data obtained from the one or more sensors; transmitting, via the I/O ports of the controller of one or more of the host vehicle and the I/O ports of the one or more remote vehicles, the event information to the cloud computing server; and assessing a physical location and proximity of the host vehicle to remote vehicles participating in the method. The MIROP application further includes: assessing a road surface condition of a road segment upon which the host vehicle is traveling; estimating a traffic density on the road segment; and aggregating host vehicle behavioral data and identifying event IDs within the host vehicle behavioral data. The MIROP application further includes: computing a vehicle operator insurability score; automatically notifying an insurance carrier of the vehicle operator insurability score; and automatically presenting to a host vehicle operator, via a human-machine interface (HMI), score information and vehicle operation suggestions to improve the vehicle operator insurability score.

In yet another aspect of the present disclosure the method further includes: detecting event information comprising: instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy. The method further includes: comparing instances of host vehicle and/or remote vehicle hard braking, hard acceleration, and hard cornering to threshold acceleration, braking, and cornering values; and periodically transmitting event information, relating to the instances of host vehicle and/or remote vehicle hard braking, hard acceleration and hard cornering that meet or exceed the threshold acceleration, braking, and cornering values, to the cloud computing server.

In yet another aspect of the present disclosure the method further includes: confirming a location of the host vehicle relative to map information stored in a map database, and determining a location of the one or more remote vehicles relative to map information stored in the map database. The method further includes determining that one or more of the remote vehicles is at or below a threshold physical distance of the host vehicle, or that one or more of the remote vehicles has traversed the road segment at or within a threshold quantity of time relative to the host vehicle.

In yet another aspect of the present disclosure the method further includes: utilizing data from the one or more sensors to estimate a road surface type, a road surface condition, a presence or absence of obstacles on the road segment, a location of lane markings on the road segment; and obtaining information from one or more application programming interfaces (APIs) including a weather API. The weather API provides weather information for the environment surrounding the host vehicle on the road segment.

In yet another aspect of the present disclosure the method further includes: obtaining information from one or more application programming interfaces (APIs) including one or more traffic APIs. The traffic APIs report, to the host vehicle, current and historical traffic information about the road segment; and utilizing data from the traffic API and from the one or more sensors to estimate a traffic density including traffic signal status at approximately a one second accuracy, and that determines when the host vehicle is approaching or passing through a traffic signal.

In yet another aspect of the present disclosure the method further includes: identifying event IDs corresponding to instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy. The method further includes determining when one or more remote vehicle perspectives is available. Upon determining that one or more remote vehicle perspectives is available the method utilizes the remote vehicle perspectives to provide context to behavior of the host vehicle; and accesses a road profile database that includes physical characteristics of the road segment, and contextual information, including traffic data, time of day information, and road surface information relating to the road segment.

In yet another aspect of the present disclosure the method further includes: calculating first order vehicle operator driving characteristics including: calculating aggressiveness x(t), via sudden acceleration a(t) and close following distances b(t); calculating an average aggressiveness according to:

$$( {p}_{1}^{i} ) : \overline{{x}_{ι}} = {\sum }_{t = 1}^{T} \frac{{x}_{i} ( t )}{T} ; \qquad II .$$

calculating a derived time series for vehicle operator driving parameters of interest, including: calculating a standard deviation in aggressiveness according to:

$$( {p}_{2}^{i} ) : {\tilde{x}}_{ι} = \sqrt{{\sum }_{t = 1}^{T} \frac{( {x}_{i} ( c ) - \overline{x} )}{T - 1}} ; \qquad III .$$

calculating a vehicle operator aggressiveness trend over time according to:

$$( {p}_{a}^{i} ) : {\hat{β}}_{ι} = \frac{{\sum }_{i = 0}^{n} ( {x}_{i} - \overline{x} ) ( {Y}_{i} - \overline{y} )}{{\sum }_{i = 0}^{n} {( {x}_{i} - \overline{x} )}^{2}} > 0 ; \qquad IV .$$

where (xᵢ−x̅)² is a normalizing characteristic, and \hat{β}_{ι} indicates whether the vehicle, operator is becoming more, less, or equally aggressive over a predefined quantity of time. The method further includes calculating a cumulative distribution function (CDF) that ranks all participating host and remote vehicle operator performance according to:

$${\sum }_{i = 0}^{n} {w}_{i} * rank ( {a}_{1} , {Q}_{1} ) ; \qquad I .$$

where each aₙ defines a characteristic of a particular event Qₙ on a per-vehicle n basis, and wᵢ defines weighting factors; and determining a relative performance of the vehicle operator in comparison with similarly-situated remote vehicle operators in similar contexts over the road segment or similar road segments.

In yet another aspect of the present disclosure the method further includes: selectively notifying an insurance carrier of the vehicle operator insurability score based on one or more of: a predetermined time schedule, a quantity of distance traveled by the host vehicle operator, identified behavioral changes, host vehicle location changes, and host vehicle commute pattern changes; and presenting the operator score information and vehicle operation suggestions on one or more of: an infotainment display of the host vehicle, an instrument cluster of the host vehicle, an interior rear-view screen of the host vehicle, a cellular device, a laptop computer, and a tablet computer. The vehicle operation suggestions include: score improvement advice, driving behavior improvement suggestions; driving route modification suggestions, and host vehicle mode selection suggestions.

In several additional aspects of the present disclosure a method for measuring insurability based on relative vehicle operator performance includes: capturing, via one or more sensors, information about a host vehicle and one or more remote vehicles, and capturing environmental information about an environment surrounding the host vehicle and the one or more remote vehicles. The method further includes utilizing a cloud computing server in communication with the host vehicle and the one or more remote vehicles, and utilizing one or more controllers disposed in each of the host vehicle, the one or more remote vehicles, and the cloud computing server. The controllers each include a processor, a memory, and one or more input/output (I/O) ports. The I/O ports are in communication with the one or more sensors. The memory stores programmatic control logic. The processor executes the programmatic control logic. The programmatic control logic includes an application for measuring insurability based on relative vehicle operator performance (MIROP application). The MIROP application includes: identifying event information within data obtained from the one or more sensors, including: detecting event information comprising: instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy. The MIROP application further includes comparing instances of host vehicle and/or remote vehicle hard braking, hard acceleration, and hard cornering to threshold acceleration, braking, and cornering values. The MIROP application further includes periodically transmitting, via the I/O ports of the controller of one or more of the host vehicle and the I/O ports of the one or more remote vehicles, event information, relating to the instances of host vehicle and/or remote vehicle hard braking, hard acceleration and hard cornering that meet or exceed the threshold acceleration, braking, and cornering values, to the cloud computing server. The MIROP application further includes assessing a physical location and proximity of the host vehicle to remote vehicles participating in the method, including: confirming a location of the host vehicle relative to map information stored in a map database; determining a location of the one or more remote vehicles relative to map information stored in the map database; and determining that one or more of the remote vehicles is at or below a threshold physical distance of the host vehicle, or that one or more of the remote vehicles has traversed a road segment at or within a threshold quantity of time relative to the host vehicle. The MIROP application further includes assessing a road surface condition of a road segment upon which the host vehicle is traveling, including: utilizing data from the one or more sensors to estimate a road surface type, a road surface condition, a presence or absence of obstacles on the road segment, a location of lane markings on the road segment; and obtaining information from one or more application programming interfaces (APIs) including a weather API. The weather API provides weather information for the environment surrounding the host vehicle on the road segment. The MIROP application further includes estimating a traffic density on the road segment, including: obtaining information from one or more application programming interfaces (APIs) including one or more traffic APIs. The traffic APIs report, to the host vehicle, current and historical traffic information about the road segment. The MIROP application further includes utilizing data from the traffic API and from the one or more sensors to estimate a traffic density including traffic signal status at approximately a one second accuracy, and determines when the host vehicle is approaching or passing through a traffic signal. The MIROP application further includes aggregating host vehicle behavioral data and identifying event IDs within the host vehicle behavioral data, including: identifying event IDs corresponding to instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy. The MIROP application further includes determining when one or more remote vehicle perspectives is available. Upon determining that one or more remote vehicle perspectives is available the method utilizes the remote vehicle perspectives to provide context to behavior of the host vehicle. The MIROP application further includes accessing a road profile database that includes physical characteristics of the road segment, and contextual information, including traffic data, time of day information, and road surface information relating to the road segment. The MIROP application further includes computing a vehicle operator insurability score, including: calculating first order vehicle operator driving characteristics; calculating a derived time series for vehicle operator driving parameters of interest; and applying weighting factors to each to determine a relative performance of the vehicle operator in comparison with similarly-situated remote vehicle operators in similar contexts over the road segment or similar road segments. The MIROP application further includes calculating aggressiveness x(t), via sudden acceleration a(t) and close following distances b(t); calculating an average aggressiveness according to:

$$( {p}_{1}^{i} ) : \overline{{x}_{ι}} = {\sum }_{t = 1}^{T} \frac{{x}_{i} ( t )}{T} ; \qquad II .$$

calculating a standard deviation in aggressiveness according to:

$$( {p}_{2}^{i} ) : {\tilde{x}}_{ι} = \sqrt{{\sum }_{t = 1}^{T} \frac{( {x}_{i} ( c ) - \overline{x} )}{T - 1}} ; \qquad III .$$

and calculating a vehicle operator aggressiveness trend over time according to:

$$( {p}_{a}^{i} ) : {\hat{β}}_{ι} = \frac{{\sum }_{i = 0}^{n} ( {x}_{i} - \overline{x} ) ( {Y}_{i} - \overline{y} )}{{\sum }_{i = 0}^{n} {( {x}_{i} - \overline{x} )}^{2}} > 0 ; \qquad IV .$$

where (xᵢ−x̅)² is a normalizing characteristic, and \hat{β}_{ι} indicates whether the vehicle 12, 12′ operator is becoming more, less, or equally aggressive over a predefined quantity of time. The MIROP application further includes calculating a cumulative distribution function (CDF) that ranks all participating host and remote vehicle operator performance according to:

$${\sum }_{i = 0}^{n} {w}_{i} * rank ( {a}_{1} , {Q}_{1} ) ; \qquad I .$$

where each aₙ defines a characteristic of a particular event Qₙ on a per-vehicle n basis, and wᵢ defines the weighting factors. The MIROP application further includes automatically notifying an insurance carrier of the vehicle operator insurability score, including: selectively notifying an insurance carrier of the vehicle operator insurability score based on one or more of: a predetermined time schedule, a quantity of distance traveled by the host vehicle operator, identified behavioral changes, host vehicle location changes, and host vehicle commute pattern changes. The MIROP application further includes automatically presenting to a host vehicle operator, via a human-machine interface (HMI), score information and vehicle operation suggestions to improve the vehicle operator insurability score, including: presenting the operator score information and vehicle operation suggestions on one or more of: an infotainment display of the host vehicle, an instrument cluster of the host vehicle, an interior rear-view screen of the host vehicle, a cellular device, a laptop computer, and a tablet computer. The vehicle operation suggestions include: score improvement advice, driving behavior improvement suggestions, driving route modification suggestions, and host vehicle mode selection suggestions.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for measuring insurability based on relative vehicle operator performance according to an exemplary embodiment;

FIG. 2A is an image of a map of a road segment along which the system for measuring insurability based on relative vehicle operator performance of FIG. 1 is applied according to an exemplary embodiment;

FIG. 2B is a chart depicting event information and a score ranking for a plurality of vehicles traversing the road segment of FIG. 2A and utilizing the system for measuring insurability based on relative vehicle operator performance of FIG. 1 according to an exemplary embodiment;

FIG. 2C is a is a graphical representation of a cumulative distribution function (CDF) depicting relative performance of the plurality of vehicles of FIG. 2B and utilizing the system for measuring insurability based on relative vehicle operator performance of FIG. 1 according to an exemplary embodiment; and

FIG. 3 is a flowchart depicting a method for measuring insurability based on relative operator performance according to an exemplary embodiment.

### DETAILED DESCRIPTION

The following description is merely exemplary in nature and is not intended to limit the present disclosure, application, or uses.

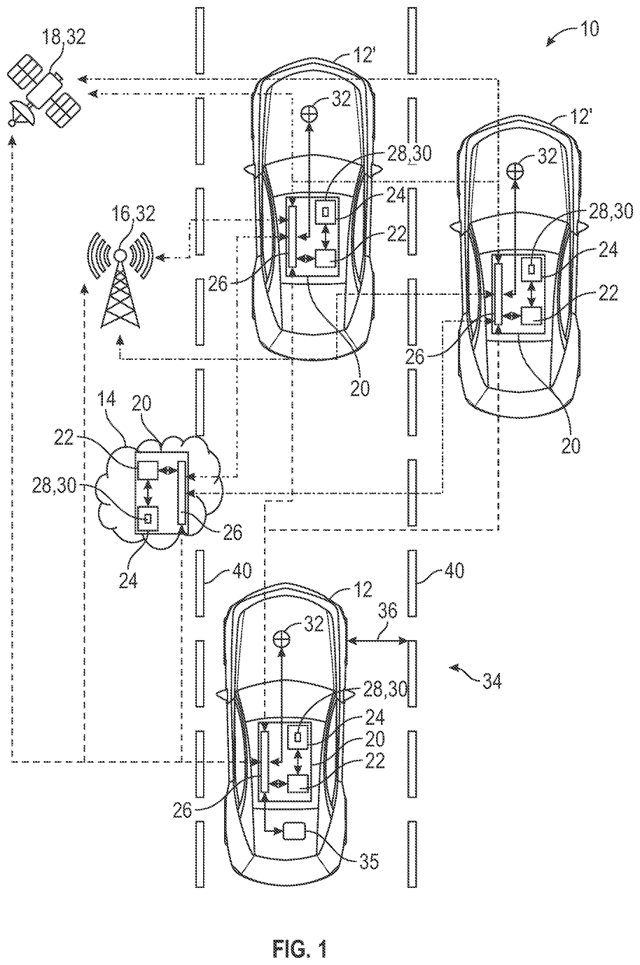

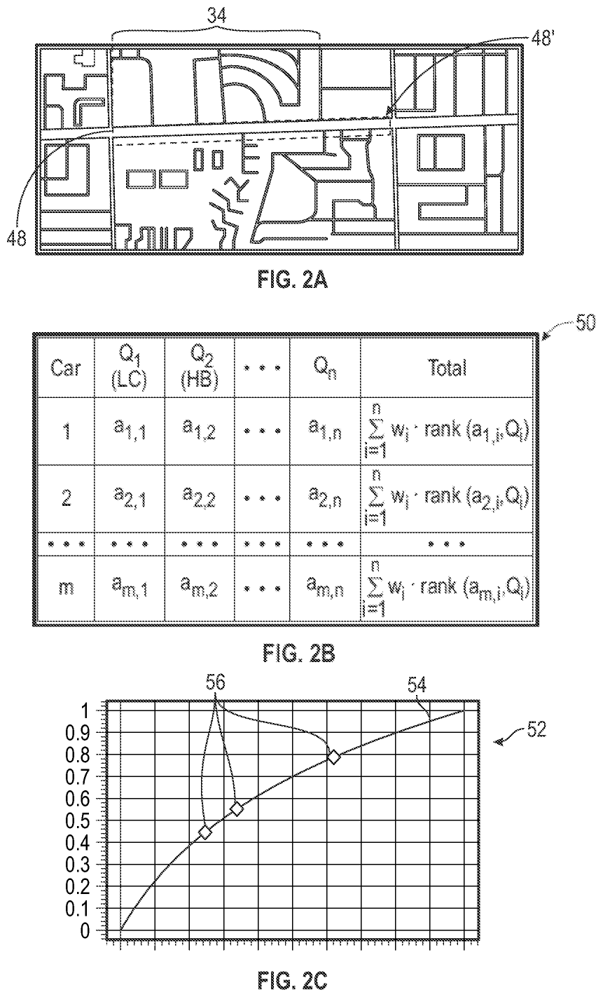

Referring to FIGS. 1, 2A, 2B, and 2C, a system 10 for measuring insurability based on relative operator performance is shown. The system 10 generally includes one or more vehicles 12, such as a host vehicle 12 and a remote back-office or cloud-computing server 14, and may further include infrastructure, such as one or more cellular towers 16, Global Positioning System (GPS) satellites 18, traffic signaling devices (not specifically shown), or the like. While the host vehicle 12 shown is a sports car, it should be appreciated that the host vehicle 12 may be any of a wide variety of vehicles 12 including but not limited to cars, trucks, sport-utility vehicles (SUVs), buses, semi-tractors, tractors used in farming or construction or the like, watercraft, aircraft such as planes or helicopters or the like without departing from the scope or intent of the present disclosure. Additional remote vehicles 12′ may also be included in the system 10 without departing from the scope or intent of the present disclosure.

The host vehicle 12, remote vehicles 12′ and the cloud-computing server 14 each include one or more controllers 20. The controllers 20 are non-generalized, electronic control devices having a preprogrammed digital computer or processor 22, non-transitory computer readable medium or memory 24 used to store data such as control logic, software applications, instructions, computer code, data, lookup tables, etc., and a transceiver or input/output (I/O) ports 26. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable memory 24 excludes wired, wireless, optical, or other communication links that transport transitory electrical or other signals. A non-transitory computer readable memory 24 includes media where data can be permanently stored and media where data can be stored and later overwritten, such as a rewritable optical disc or an erasable memory device. Computer code includes any type of program code, including source code, object code, and executable code. The processor 22 is configured to execute the code or instructions. In vehicles 12, the controller 20 may be a dedicated Wi-Fi controller or an engine control module, a transmission control module, a body control module, an infotainment control module, etc. The I/O ports 26 are configured to wirelessly communicate using Wi-Fi protocols under IEEE 802.11x, cellular protocols such as global system for mobile communications (GSM), code division multiple access (CDMA), wireless in local loop (WLL), general packet radio services (GPRS), 1G, 2G, 3G, 4G long term evolution (LTE), 5G, or the like.

The memory 24 may store one or more applications 28. An application 28 is a software program configured to perform a specific function or set of functions. The application 28 may include one or more computer programs, software components, sets of instructions, procedures, functions, objects, classes, instances, related data, or a portion thereof adapted for implementation in a suitable computer readable program code. The applications 28 may be stored within the memory 24 of the on-board controllers 20 in the vehicles 16, or in additional or separate memory, such as within a memory 24 of a cloud computing device such as the cloud computing server 14. Examples of the applications 28 include audio or video streaming services, games, browsers, social media, and an application for measuring insurability based on relative operator performance (MIROP) 30.

The host vehicle 12 acquires and/or generates operational information from a variety of sources including, but not limited to: one or more sensors 32 disposed on the host vehicle 12 and captures host vehicle 12 information including host vehicle 12 telematics and communications information such as host vehicle 12 speed, host vehicle 12 location information, host vehicle 12 altitude, and the like. In several aspects, the sensors 32 disposed on the host vehicle 12 may include any of a wide variety of sensor types, including but not limited to sensors 32 for detecting optical or electromagnetic information about the host vehicle 12, remote vehicles 12′, an environment surrounding the host and remote vehicles 12, 12′, and the like. The sensors 32 may include, but are not limited to: cameras, Light Detection and Ranging (LiDAR) sensors, Radio Detection and Ranging (RADAR) sensors, Sound Navigation and Ranging (SONAR) sensors, ultrasonic sensors, or combinations thereof. The sensors 32 may further motion sensors, such as inertial measurement units (IMUs). IMUs measure and report attitude or position, linear velocity, acceleration, and angular rates relative to a global reference frame using a combination of some or all of the following: accelerometers, gyroscopes, and magnetometers. In some examples, IMUs may also utilize global positioning system (GPS) data to indirectly measure attitude or position, velocity, acceleration, and angular rates of the host vehicle 12 and/or of the one or more remote vehicles 12′.

In further examples, the host vehicle 12, remote vehicles 12′ and/or the remote cloud-computing server 14 may acquire environmental data about the area surrounding the host vehicle 12 such as traffic condition information, road condition and road surface information, weather information, and the like from remote sensor 32 sources such as sensors 32 of infrastructure including the GPS satellites 18, cellular towers 16, or roadside sensing devices, and the like.

The system 10 aggregates host vehicle 12 driving data over a road segment 34 and per host vehicle 12 trip to characterize host vehicle 12 operator performance. The host vehicle 12 operator performance may be presented to the host vehicle 12 operator via a human-machine interface (HMI) 35. In several aspects, the HMI 35 includes one or more devices capable of presenting information to and interacting with the host vehicle 12 operator, such as a screen disposed within the host vehicle 12 such as an instrument cluster, an infotainment screen, a heads-up display (HUD), an interior rear-view screen such as a rear-view mirror augmented by a screen. In further examples, the HMI 35 may be a device partially or entirely separate from the host vehicle 12, such as an operator's cellular device, laptop or tablet computer, or other such third party device in communication with the controller(s) 20 of the host vehicle 12, or the like.

The driving data may include any of a wide variety of data including instances of hard braking, late night driving, hard acceleration, hard cornering, and the like, as well as distances driven, clock time, fuel economy, average speed, speed equal to or greater than a threshold speed, seat belt status, stability control status, frontal collision avoidance (FCA) events, lane-departure warning (LDW) events, and the like. In several aspects, it should be appreciated that hard or harsh braking, hard or harsh acceleration, and/or hard cornering or rapid steering input may be characterized by the detection of acceleration that meets or exceeds a threshold acceleration value. For example, a threshold for hard or harsh acceleration and/or braking may be defined as greater than or equal to 0.3 G, where G is the acceleration of the force of gravity. Likewise, a threshold for hard cornering or rapid steering input may be defined as greater than or equal to 0.6 G. However, it should be appreciated that the thresholds for hard or harsh acceleration and/or braking and the thresholds for hard cornering may vary substantially from application to application, from vehicle to vehicle, and from situation to situation without departing from the scope or intent of the present disclosure.

In further aspects, the host vehicle 12 obtains vehicle data from the sensors 32 operating on the controller area network (CAN) bus 33 of the host vehicle 12, including following distances behind additional remote vehicles 12′, congested driving status based on headway, side object data, camera data, and the like. Host vehicle 12 speed relative to the speed limit and/or an ambient average speed of traffic may also be recorded for a particular road segment 34. The sensors 32 may also scan an area around the host vehicle 12 to determine a host vehicle 12 position or host vehicle 12 offset deviation 36 within a lane 38 along the road segment 34. In several aspects, a host vehicle 12 offset deviation 36 is a relative position of the host vehicle 12 within the lane 38 and relative to lane markings 40 or lane 38 edges (not specifically shown), especially in comparison with positions of other remote vehicles 12′ within the same lane 38 at a similar point in time. The sensors 32 record lane 38 changes, lane 38 change attempts and lane 38 change aborts such as lane 38 change attempts with advanced driver assistance system (ADAS) alerts and/or corrections.

Sensors 32 mounted to infrastructure or on GPS satellites 18 may add record host vehicle 12 behavior information including but not limited to: turn-on-red violations, wrong-way driving, urban and/or highway driving, or the like on a per-trip basis or continuously. Likewise sensors 32 of the host vehicle 12 and sensors 32 of other vehicles 12′ and/or infrastructure may perform microscopic collaborative behavior analysis based on locally sensed host vehicle 12 data. For example, the sensors 32 of the host vehicle 12, other vehicles 12′ and/or infrastructure may determine host vehicle 12 behavior traits such as not yielding to crossing vehicles 12′, cut-in behavior, rapid steering movements such as swerving behavior, remote horn activation, late braking events, braking behavior that deviates from behavior of other vehicles 12′ in surrounding traffic, and in-host vehicle 12 control or app usage. In several aspects, the above-described data is collected on a per-road segment 34 basis and enables comparisons between other vehicles 12′ on the same road segment 34 and/or on a per-trip basis. Normalized measurements of host vehicle 12, 12′ behavior are made by quantifying a number of events per road segment 34, per trip, per day, or the like. In several aspects, the events described herein are classified into a list of event identifiers (event IDs) that characterize vehicle 12, 12′ behavior while the vehicle 12, 12′ is in operation.

In several aspects, the sensor 32 data may be obtained and analyzed on a periodic basis, enabling continuous measurement over time. That is, the sensor 32 data maybe aggregated per road segment 34 and host vehicle 12 operator behavior scored based on relative deviations from a norm such as a delta of speed between the host vehicle 12 and surrounding traffic, or lane 38 tracking relative to other remote vehicles 12′.

In additional aspects, the sensor 32 data may be obtained and analyzed on a per-event basis, enabling characterization of intentional or reactive events and/or providing the ability to assess fault in a particular event instance. Events, such as hard braking, lane 38 changes, and the like are recorded. Anomalous local events initiate a comparison of a scenario at a current point in time and evaluates the vehicles 12, 12′ involved to determine which vehicles 12, 12′ reacted “correctly” and which vehicles 12, 12′ may be “at fault.” For example, a host vehicle 12 that fails to yield right-of-way to another host vehicle 12′ that arrived at a particular intersection 48 in the road might be characterized as “at fault.” Likewise, a leading host vehicle 12 (not specifically shown) that brakes at a higher intensity than required and causes a following remote vehicle 12′ to initiate a hard-braking event may similarly be characterized as “at fault” even if the following remote vehicle 12′ collides with the leading host vehicle 12, depending on the circumstances.

In several aspects, the contexts or situations in which hard or harsh acceleration, braking, or hard cornering occurs drives the threshold acceleration values. For example, a host vehicle 12 accelerating on a short highway entrance ramp from a surface street to an interstate highway may cause the host vehicle 12 operator to apply full or nearly full throttle, thereby causing the host vehicle 12 to exceed the 0.3 G threshold that would otherwise be applicable to the same host vehicle 12 when the host vehicle 12 is being driven along on a surface street in a low-traffic situation. That is, the threshold acceleration value for a highway entrance ramp might exceed the threshold acceleration value applicable to surface-street driving, without departing from the scope or intent of the present disclosure. Similarly, the system 10 may utilize data from a variety of sensor 32 sources to determine a road profile over a period of time. The road profile may include the physical characteristics of a road segment 34, such as: a quantity of lanes 38 within the road segment 34; a road surface type (i.e. dirt, gravel, cement, asphalt, or the like); the presence or absence of obstacles such as potholes, curbs, or the like along the road segment 34; a location of lane markings 40 on the road segment 34; a typical traffic pattern along the road segment 34 at a particular time of day, and the like. For example, a road segment 34 in a downtown portion of a major metropolis, such as Manhattan, Tokyo, or the like, will experience higher vehicular traffic during morning and afternoon rush-hours than an otherwise physically similar road segment 34 in a rural location. Road segments 34 are sub-divided into sub-segments of a predefined length. In an example, the predefined length of the sub-segments is approximately five-hundred (500) meters, however, the predefined length may vary substantially from 500 meters without departing from the scope or intent of the present disclosure. In further examples, the road segments 34 may be sub-divided based on the locations of crossroads or intersections 48, or from a full trip as defined by a key cycle (i.e. key on to key off), or the like. Such data is then normalized over a trip, or a series of trips.

Events are defined as a response by one host vehicle 12 through analysis of local sensor 32 data and/or comparison of evidence from each host vehicle 12, 12′ within the cloud computing server 14. License plate information for each host vehicle 12, 12′ may be obtained by the sensors 32 and used to provide a negative impact to an insurability score based on a lookup table stored in the cloud computing server 14 memory 24. In several aspects, the insurability score is defined through a relative ranking process based on utility function calculations and/or cumulative distribution functions (CDFs) that can be used to extract individual scores.

Turning now more particularly to FIGS. 2A, 2B, and 2C and with continuing reference to FIG. 1, an exemplary road segment 34 is shown in FIG. 2A along with a chart 50 in FIG. 2B and a graphical representation 52 of CDF data extracted from chart 50 in FIG. 2C. Specifically, the road segment 34 extends from a first intersection 48 to a second intersection 48′. Data obtained from sensors 32 relating to a plurality of host and remote vehicles 12, 12′ along the exemplary road segment 34 is acquired, accumulated, and used within the CDFs and/or utility function calculations to extract individual scores on a per vehicle 12, 12′ basis. The left-most column of FIG. 2B includes an identifier for each vehicle 12, 12′ that is traveling, or which has traveled along the exemplary road segment 34 over a known period of time. Columns Q₁ through Qₙ include data obtained from sensors 32 that relates to specific event metrics. For example, column Q₁ includes lane 38 change (LC) information for each vehicle 12, 12′. Column Q₂ includes hard braking events for each vehicle 12, 12′, and so forth. A total ranking of all Q₁ through Qₙ event data is shown in the right-most column as:

$${\sum }_{i = 0}^{n} {w}_{i} * rank ( {a}_{1} , {Q}_{1} ) ; \qquad I .$$

for each vehicle 12, 12′ (i.e. vehicle 1, 2, . . . m shown in the left-most column of the chart 50 of FIG. 2B. Relative rankings of each of the vehicles 12, 12′ in the chart 50 may then be graphically represented as shown in FIG. 2C as a CDF distribution line 54. Each data point 56 along the CDF distribution line 54 defines a distinct vehicle 12, 12′ ranking. In several aspects, the ranking for each vehicle 12, 12′ is defined by at least first and second-order driving characteristics. First-order driving characteristics may include aggressiveness X(t) via sudden acceleration a(t) and close following distances b(t), and the like. Second-order driving characteristics include a derived time series for the first-order driving characteristics and to which weighting factors are applied according to an average, standard deviation, and trend. The average may be represented as:

$$( {p}_{1}^{i} ) : \overline{{x}_{ι}} = {\sum }_{t = 1}^{T} \frac{{x}_{i} ( t )}{T} ; \qquad II .$$

which defines an average aggressiveness X(t) of a particular vehicle 12, 12′ operator. Similarly, the standard deviation may be represented as:

$$( {p}_{2}^{i} ) : \tilde{{x}_{ι}} = \sqrt{{\sum }_{t = 1}^{T} \frac{( {x}_{i} ( t ) - \overline{x} )}{T - 1}} ; \qquad III .$$

which defines a boundary of the particular vehicle 12, 12′ operator's aggressiveness. The trend, which may be represented as:

$$( {p}_{a}^{i} ) : \hat{{β}_{ι}} = \frac{{\sum }_{i = 0}^{n} ( {x}_{i} - \overline{x} ) ( {y}_{i} - \overline{y} )}{{\sum }_{i = 0}^{n} {( {x}_{i} - \tilde{x} )}^{2}} > 0 ; \qquad IV .$$

where (xᵢ−x̅)² is a normalizing characteristic, and \hat{β}_{ι} indicates whether the vehicle 12, 12′ operator is becoming more, less, or equally aggressive over a predefined quantity of time. In several aspects, the \hat{β}_{ι} trend may be thought of as a change in relative aggressiveness X(t) in comparison with other vehicle 12, 12′ operators in similar conditions over the predefined quantity of time. The predefined quantity of time may vary from application to application, and situationally, however, in some examples, the predefined quantity of time may be approximately four to six weeks.

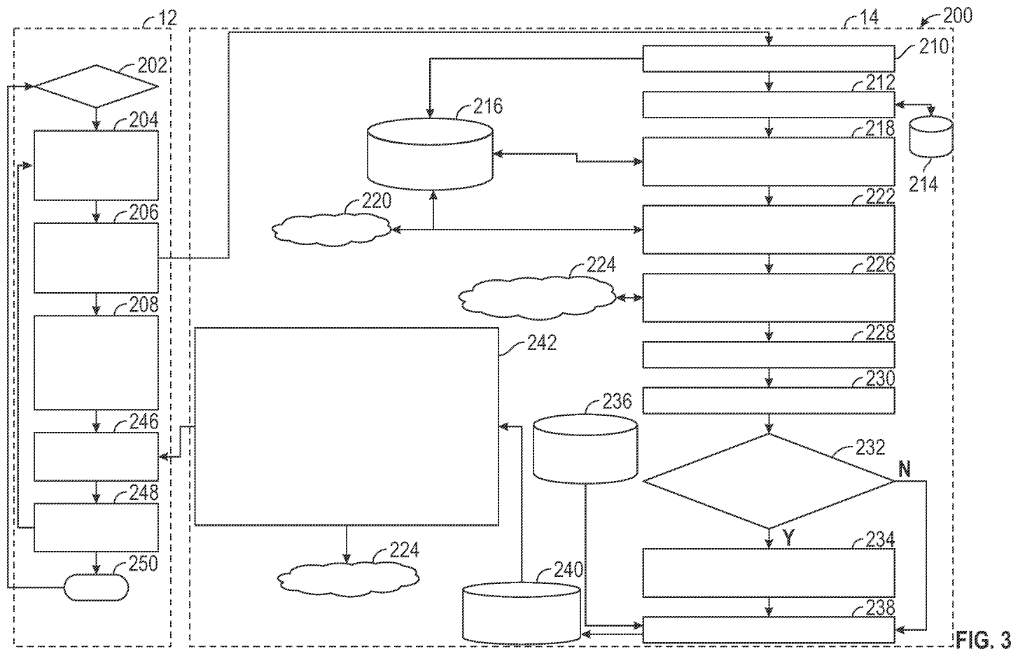

Referring now to FIG. 3, and with continuing reference to FIGS. 1, 2A, 2B, and 2C, the control logic executed within the MIROP application 30 is shown as a plurality of method 200 steps in flowchart form. The method 200 begins at block 202 when the host vehicle 12 is turned on by a host vehicle 12 operator. At block 204, when the host vehicle 12 is on, the CAN bus 33 performs event detection based on data obtained from sensors 32 on the vehicle. The event detection may include location, time, event IDs, and the like, as well as a map. At block 206, the system 10 performs target classification from sensors 32 communicating on the CAN bus 33. The target classification may include other information about remote vehicles 12′, road segment 34 information and the like. At block 208, the system 10 periodically transmits, via the I/O ports of the host vehicle 12 controllers 20, host vehicle 12 location information, event IDs and the like to the cloud-computing server 14. At block 210, within the cloud-computing server 14, the system 10 receives the periodic transmissions from the host vehicle 12 with a message handler. At block 212, the system 10 compares the host vehicle 12 location information to map information stored in a map database 214 to confirm the location reported by the host vehicle 12. The message handler of the cloud-computing server 14 sends the periodic transmissions from the host vehicle 12 to a crowd-sourced database at block 216. In several aspects, the crowd-sourced database includes the periodic transmissions not only from the host vehicle 12, but from other remote vehicles 12′ that utilize the MIROP application 30. At block 218, the system 10 engages control logic that performs a lookup function to ascertain which participating remote vehicles 12′ may be reporting or may have reported relevant data for the MIROP application 30. In several aspects, the participating remote vehicles 12′ that are relevant may be at or below a predefined or variable threshold physical distance of the host vehicle 12, or may have traversed a relevant road segment 34 within a predefined or variable threshold quantity of time for which the data reported by the remote vehicles 12′ may accurately be applied to the state of the host vehicle 12. At block 220, the system 10 engages control logic to obtain weather information from one or application programming interfaces (APIs), such as a weather API provided by a national weather service, or the like. Other sources of weather information, such as local weather service APIs, crowd-sourced weather information obtained from remote vehicles 12′ and/or infrastructure, or the like. Weather data from block 220 is forwarded to the crowd-sourced database at block 216. From block 218, the method 200 proceeds to block 222 where the MIROP application 30 estimates road surface conditions on relevant road segments 34 based on information from block 218 and from the weather data obtained at block 220.

From block 222, the MIROP application 30 proceeds to block 224. At block 224, the MIROP application 30 calls on traffic APIs to obtain current and historical traffic information on the road segment 34. In several aspects, the traffic APIs may be hosted in one or more cloud-computing servers 14, and may obtain and relate to the MIROP application 30 and system 10 the status of traffic signals, and the like. Further, the traffic APIs may send and receive information about traffic violations, such as a quantity of red traffic signal or stop sign through which one or more vehicles 12, 12′ have improperly passed, or a quantity or relative rate at which the one or more vehicles 12, 12′ are passing through yellow traffic signals, and/or an acceleration rate of the one or more vehicles 12, 12′ as they pass through a yellow traffic signal or a red traffic signal, or the like. Traffic violation information may stored within one or more traffic violation databases within the cloud-computing servers 14, or the like, and the data contained therein may be compared to the behavior of the host vehicle 12 and one or more remote vehicles 12′.

At block 226, the MIROP application 30 utilizes the data from blocks 222 and 224 to generate a traffic density estimate. The traffic density estimate accounts for traffic signal status at approximately +/− one second accuracy, and utilizes host vehicle 12 data to determine whether the host vehicle 12 is approaching or passing through a traffic signal on the road segment 34, including determining whether the host vehicle 12 is running through yellow or red traffic signals or otherwise committing traffic violations as listed within the traffic violation databases. At block 228, control logic within the MIROP application 30 is executed to aggregate periodic data from the host vehicle 12, from remote vehicles 12′, and from sensors 32 of infrastructure, and the like. In addition, at block 228, the control logic of the MIROP application 30 aggregates information from current and historical vehicles 12, 12′ passing along the relevant road segment 34 within a predefined quantity of time that has been selected to be relevant to the present contextual situation of the host vehicle 12. At block 230, the method 200 executes control logic of the MIROP application 30 that determines event IDs within the data.

At block 232, the method 200 executes control logic of the MIROP application 30 that determines whether a remote vehicle 12′ perspective is available. That is, when a remote vehicle 12′ is within a predefined distance of the host vehicle 12 during a predefined quantity of time along the same road segment 34 as the host vehicle 12, the MIROP application 30 may determine that the remote vehicle 12′ can provide a relevant remote vehicle perspective that provides context to the behavior of the host vehicle 12. When a remote vehicle 12′ perspective is available, the method 200 proceeds to block 234 where the MIROP application 30 performs event analysis and generates consensus information. In several aspects, the consensus information includes a relative assessment of host vehicle 12 operator driving behavior in relation to behavioral norms to accurately assess vehicle 12 operator risk based on context.

At block 236 the method causes control logic of the MIROP application 30 to access a road profile database hosted in a cloud-computing server 14. When a remote vehicle 12′ perspective is unavailable or when the event analysis and consensus are complete, the method 200 proceeds to block 238 where the road profile from block 236 is used to generate a host vehicle 12 operator score. In several aspects, the host vehicle 12 operator score defines a relative level of risk of the host vehicle 12 operator as compared to other similarly-situated remote vehicle 12′ operators in similar contexts over the same or similar road segments 34 or which have traveled along the same or similar road segments 34 or performed the same or similar trips under contextually similar conditions.

From block 238, the method 200 proceeds to block 240 where the host vehicle 12 operator scores are added to a performance database. The performance database. The performance database is stored within memory 24 of the one or more cloud-computing servers 14, and includes records of host vehicle 12 operator scores aggregated over time. From the performance database at block 240, the method 200 proceeds to block 242 where host vehicle 12 operator score information is periodically packaged for transmission to an insurance carrier at block 244, and/or to a data handler 246 within the host vehicle 12. In several aspects, the packaged information may be transmitted based on a predetermined time schedule, a quantity of distance travelled by the host vehicle 12 operator and/or based on a behavioral changes, location changes, commute pattern changes, or the like. Behavioral changes may include, but are not limited to, changes in driving habits, such as acceleration and deceleration rates, the frequency of turn-signal usage during lane changes, or the like. In further examples, the behavior changes may include commute pattern changes, such as alternate route usage, the use of or lack of use of surface streets in place of highway travel, or the like.

At block 244, the insurance carrier may use the host vehicle 12 operator performance information from the performance database to determine whether a particular host vehicle 12 operator is continuing to operate the host vehicle 12 in a consistent manner, and/or whether the host vehicle 12 operator has changed behavior to operate the host vehicle 12 in a manner that indicates increased or decreased assessed risk. Insurance carriers may then alter insurance rates based on increased assessed risk, decreased assessed risk, or the like.

From block 246, the MIROP application 30 forwards the host vehicle 12 operator score information to the HMI 35 at block 248. The host vehicle 12 operator score information may be presented on the HMI 35 in a number of different ways without departing from the scope or intent of the present disclosure. In some examples, the host vehicle 12 operator score information may be presented along with score improvement advice, driving behavior improvement suggestions, driving route modification suggestions, host vehicle 12 mode selection suggestions, or the like. From block 248, the method 200 returns to either the CAN event detection at block 204 while the host vehicle 12 is in operation in a key-on state, or proceeds to block 250, when the host vehicle 12 is in a key-off state. At block 250 the method 200 ends. From block 250, the method 200 returns to block 202 where the method 200 may be initiated again when the ignition of the host vehicle 12 is once again engaged in a key-on state.

A system 10 and method 200 for measuring insurability based on relative vehicle 12 operator performance of the present disclosure offers several advantages. These include the ability to derive a high fidelity estimation of vehicle 12 operator performance based on how a vehicle 12 operator behaves compared to other vehicle 12 operators at substantially the same time and at substantially the same geographical location. The system 10 and method 200 effectively and efficiently aggregate driving data per road segment 34, per trip, and the like, and score behavior based on relative deviation from behavioral norms to accurately assess vehicle 12 operator risk based on context, while minimizing false positives due to road design, effectively and accurately determining relative braking, lateral acceleration, speed consistency of a vehicle 12 operator relative to their peers, and accurately assessing vehicle 12 operator skill all while operating on existing hardware and utilizing existing systems. Thus, the system 10 and method 200 of the present disclosure substantially increase functionality and accuracy of vehicle 12 operator risk-assessment while maintaining or decreasing complexity, and while improving the accuracy of risk assessments and risk scores.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for measuring insurability based on relative vehicle operator performance, the system comprising:
a host vehicle, and one or more remote vehicles;
one or more sensors capturing host vehicle and remote vehicle information, and capturing environmental information about an environment of the host vehicle and the one or more remote vehicles; and
a cloud computing server in communication with the host vehicle and the one or more remote vehicles;
wherein each of the host vehicle, the one or more remote vehicles, and the cloud computing server has a controller, the controller including a processor, a memory, and one or more input/output (I/O) ports, the I/O ports in communication with the one or more sensors; the memory storing programmatic control logic; the processor executing the programmatic control logic; the programmatic control logic including an application for measuring insurability based on relative vehicle operator performance (MIROP application), the MIROP application comprising:
a first control logic for identifying event information within data obtained from the one or more sensors;
a second control logic for transmitting, via the I/O ports of the controller of one or more of the host vehicle and the I/O ports of the one or more remote vehicles, the event information to the cloud computing server;
a third control logic for assessing a physical location and proximity of the host vehicle to remote vehicles participating in the system;
a fourth control logic for assessing a road surface condition of a road segment upon which the host vehicle is traveling;
a fifth control logic for estimating a traffic density on the road segment;
a sixth control logic for aggregating host vehicle behavioral data and identifying event IDs within the host vehicle behavioral data;
a seventh control logic for computing a vehicle operator insurability score;
an eighth control logic for automatically notifying an insurance carrier of the vehicle operator insurability score; and
a ninth control logic for automatically presenting to a host vehicle operator, via a human-machine interface (HMI), score information and vehicle operation suggestions to improve the vehicle operator insurability score.

2. The system of claim 1, wherein the first control logic further comprises:
control logic for detecting event information comprising: instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy.

3. The system of claim 2, wherein the first control logic further comprises:
control logic for comparing instances of host vehicle and/or remote vehicle hard braking, hard acceleration, and hard cornering to threshold acceleration, braking, and cornering values; and
executing the second control logic to periodically transmit event information, relating to the instances of host vehicle and/or remote vehicle hard braking, hard acceleration and hard cornering that meet or exceed the threshold acceleration, braking, and cornering values, to the cloud computing server.

4. The system of claim 1, wherein the third control logic further comprises:
control logic for confirming a location of the host vehicle relative to map information stored in a map database;
control logic for determining a location of the one or more remote vehicles relative to map information stored in the map database; and
control logic for determining that one or more of the remote vehicles is at or below a threshold physical distance of the host vehicle, or that one or more of the remote vehicles has traversed the road segment at or within a threshold quantity of time relative to the host vehicle.

5. The system of claim 1, wherein the fourth control logic further comprises:
control logic for utilizing data from the one or more sensors to estimate a road surface type, a road surface condition, a presence or absence of obstacles on the road segment, a location of lane markings on the road segment; and
control logic for obtaining information from one or more application programming interfaces (APIs) including a weather API, wherein the weather API provides weather information for the environment surrounding the host vehicle on the road segment.

6. The system of claim 1, wherein the fifth control logic further comprises:
control logic for obtaining information from one or more application programming interfaces (APIs) including one or more traffic APIs, wherein the traffic APIs report, to the host vehicle, current and historical traffic information about the road segment; and
control logic that utilizes data from the traffic API and from the one or more sensors to estimate a traffic density including traffic signal status at approximately a one second accuracy, and that determines when the host vehicle is approaching or passing through a traffic signal.

7. The system of claim 1, wherein the sixth control logic further comprises:
control logic for identifying event IDs corresponding to instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy;
control logic for determining when one or more remote vehicle perspectives is available, wherein upon determining that one or more remote vehicle perspectives is available utilizing the remote vehicle perspectives to provide context to behavior of the host vehicle; and
control logic for accessing a road profile database that includes physical characteristics of the road segment, and contextual information, including traffic data, time of day information, and road surface information relating to the road segment.

8. The system of claim 1, wherein the seventh control logic further comprises:
control logic for calculating first order vehicle operator driving characteristics;
control logic for calculating a derived time series for vehicle operator driving parameters of interest; and
control logic for applying weighting factors to each to determine a relative performance of the vehicle operator in comparison with similarly-situated remote vehicle operators in similar contexts over the road segment or similar road segments.

9. The system of claim 8, further comprising:
control logic for calculating aggressiveness x(t), via sudden acceleration a(t) and close following distances b(t);
control logic for calculating an average aggressiveness according to:
$$( {p}_{1}^{i} ) : \overline{{x}_{ι}} = {\sum }_{t = 1}^{T} \frac{{x}_{i} ( t )}{T} ; \qquad II .$$
control logic for calculating a standard deviation in aggressiveness according to:
$$( {p}_{2}^{i} ) : \tilde{{x}_{ι}} = \sqrt{{\sum }_{t = 1}^{T} \frac{( {x}_{i} ( t ) - \overline{x} )}{T - 1}} ; \qquad III .$$
control logic for calculating a vehicle operator aggressiveness trend over time according to:
$$( {p}_{a}^{i} ) : \hat{{β}_{ι}} = \frac{{\sum }_{i = 0}^{n} ( {x}_{i} - \overline{x} ) ( {y}_{i} - \overline{y} )}{{\sum }_{i = 0}^{n} {( {x}_{i} - \tilde{x} )}^{2}} > 0 ; \qquad IV .$$
where (xᵢ−x̅)² is a normalizing characteristic, and \hat{β}_{ι} indicates whether the vehicle 12, 12′ operator is becoming more, less, or equally aggressive over a predefined quantity of time; and
control logic for calculating a cumulative distribution function (CDF) that ranks all participating host and remote vehicle operator performance according to:
$${\sum }_{i = 1}^{n} {w}_{i} * rank ( {a}_{1} , {Q}_{1} ) ; \qquad I .$$
where each aₙ defines a characteristic of a particular event Qₙ on a per-vehicle n basis, and wᵢ defines the weighting factors.

10. The system of claim 9, wherein the eighth control logic further comprises:
control logic for selectively notifying an insurance carrier of the vehicle operator insurability score based on one or more of: a predetermined time schedule, a quantity of distance traveled by the host vehicle operator, identified behavioral changes, host vehicle location changes, and host vehicle commute pattern changes.

11. The system of claim 8, wherein the ninth control logic further comprises:
control logic for presenting the operator score information and vehicle operation suggestions on one or more of: an infotainment display of the host vehicle, an instrument cluster of the host vehicle, an interior rear-view screen of the host vehicle, a cellular device, a laptop computer, and a tablet computer, wherein the vehicle operation suggestions comprise: score improvement advice, driving behavior improvement suggestions, driving route modification suggestions, and host vehicle mode selection suggestions.

12. A method for measuring insurability based on relative vehicle operator performance, the method comprising:
capturing, via one or more sensors, information about a host vehicle and one or more remote vehicles, and capturing environmental information about an environment surrounding the host vehicle and the one or more remote vehicles; and
utilizing a cloud computing server in communication with the host vehicle and the one or more remote vehicles;
utilizing one or more controllers disposed in each of the host vehicle, the one or more remote vehicles, and the cloud computing server, the controllers each including a processor, a memory, and one or more input/output (I/O) ports, the I/O ports in communication with the one or more sensors; the memory storing programmatic control logic; the processor executing the programmatic control logic; the programmatic control logic including an application for measuring insurability based on relative vehicle operator performance (MIROP application), the MIROP application comprising:
identifying event information within data obtained from the one or more sensors;
transmitting, via the I/O ports of the controller of one or more of the host vehicle and the I/O ports of the one or more remote vehicles, the event information to the cloud computing server;
assessing a physical location and proximity of the host vehicle to remote vehicles participating in the method;
assessing a road surface condition of a road segment upon which the host vehicle is traveling;
estimating a traffic density on the road segment;
aggregating host vehicle behavioral data and identifying event IDs within the host vehicle behavioral data;
computing a vehicle operator insurability score;
automatically notifying an insurance carrier of the vehicle operator insurability score; and
automatically presenting to a host vehicle operator, via a human-machine interface (HMI), score information and vehicle operation suggestions to improve the vehicle operator insurability score.

13. The method of claim 12, further comprising:
detecting event information comprising: instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy;
comparing instances of host vehicle and/or remote vehicle hard braking, hard acceleration, and hard cornering to threshold acceleration, braking, and cornering values; and
periodically transmitting event information, relating to the instances of host vehicle and/or remote vehicle hard braking, hard acceleration and hard cornering that meet or exceed the threshold acceleration, braking, and cornering values, to the cloud computing server.

14. The method of claim 12, further comprising:
confirming a location of the host vehicle relative to map information stored in a map database;
determining a location of the one or more remote vehicles relative to map information stored in the map database; and
determining that one or more of the remote vehicles is at or below a threshold physical distance of the host vehicle, or that one or more of the remote vehicles has traversed the road segment at or within a threshold quantity of time relative to the host vehicle.

15. The method of claim 12, further comprising:
utilizing data from the one or more sensors to estimate a road surface type, a road surface condition, a presence or absence of obstacles on the road segment, a location of lane markings on the road segment; and
obtaining information from one or more application programming interfaces (APIs) including a weather API, wherein the weather API provides weather information for the environment surrounding the host vehicle on the road segment.

16. The method of claim 12, further comprising:
obtaining information from one or more application programming interfaces (APIs) including one or more traffic APIs, wherein the traffic APIs report, to the host vehicle, current and historical traffic information about the road segment; and
utilizing data from the traffic API and from the one or more sensors to estimate a traffic density including traffic signal status at approximately a one second accuracy, and that determines when the host vehicle is approaching or passing through a traffic signal.

17. The method of claim 12, further comprising:
identifying event IDs corresponding to instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy;
determining when one or more remote vehicle perspectives is available, wherein upon determining that one or more remote vehicle perspectives is available utilizing the remote vehicle perspectives to provide context to behavior of the host vehicle; and
accessing a road profile database that includes physical characteristics of the road segment, and contextual information, including traffic data, time of day information, and road surface information relating to the road segment.

18. The method of claim 12, further comprising:
calculating first order vehicle operator driving characteristics including:
calculating aggressiveness x(t), via sudden acceleration a(t) and close following distances b(t);
calculating an average aggressiveness according to:
$$( {p}_{1}^{i} ) : \overline{{x}_{ι}} = {\sum }_{t = 1}^{T} \frac{{x}_{i} ( t )}{T} ; \qquad II .$$
calculating a derived time series for vehicle operator driving parameters of interest, including:
calculating a standard deviation in aggressiveness according to:
$$( {p}_{2}^{i} ) : \tilde{{x}_{ι}} = \sqrt{{\sum }_{t = 1}^{T} \frac{( {x}_{i} ( t ) - \overline{x} )}{T - 1}} ; \qquad III .$$
calculating a vehicle operator aggressiveness trend over time according to:
$$( {p}_{a}^{i} ) : \hat{{β}_{ι}} = \frac{{\sum }_{i = 0}^{n} ( {x}_{i} - \overline{x} ) ( {y}_{i} - \overline{y} )}{{\sum }_{i = 0}^{n} {( {x}_{i} - \tilde{x} )}^{2}} > 0 ; \qquad IV .$$
where (xᵢ−x̅)² is a normalizing characteristic, and \hat{β}_{ι} indicates whether the vehicle operator is becoming more, less, or equally aggressive over a predefined quantity of time;
calculating a cumulative distribution function (CDF) that ranks all participating host and remote vehicle operator performance according to:
$${\sum }_{i = 1}^{n} {w}_{i} * rank ( {a}_{1} , {Q}_{1} ) ; \qquad I .$$
where each aₙ defines a characteristic of a particular event Qₙ on a per-vehicle n basis, and wᵢ defines weighting factors; and
determining a relative performance of the vehicle operator in comparison with similarly-situated remote vehicle operators in similar contexts over the road segment or similar road segments.

19. The method of claim 18, further comprising:
selectively notifying an insurance carrier of the vehicle operator insurability score based on one or more of: a predetermined time schedule, a quantity of distance traveled by the host vehicle operator, identified behavioral changes, host vehicle location changes, and host vehicle commute pattern changes; and
presenting the operator score information and vehicle operation suggestions on one or more of: an infotainment display of the host vehicle, an instrument cluster of the host vehicle, an interior rear-view screen of the host vehicle, a cellular device, a laptop computer, and a tablet computer, wherein the vehicle operation suggestions comprise: score improvement advice, driving behavior improvement suggestions; driving route modification suggestions, and host vehicle mode selection suggestions.

20. A method for measuring insurability based on relative vehicle operator performance, the method comprising:
capturing, via one or more sensors, information about a host vehicle and one or more remote vehicles, and capturing environmental information about an environment surrounding the host vehicle and the one or more remote vehicles;
utilizing a cloud computing server in communication with the host vehicle and the one or more remote vehicles;
utilizing one or more controllers disposed in each of the host vehicle, the one or more remote vehicles, and the cloud computing server, the controllers each including a processor, a memory, and one or more input/output (I/O) ports, the I/O ports in communication with the one or more sensors; the memory storing programmatic control logic; the processor executing the programmatic control logic; the programmatic control logic including an application for measuring insurability based on relative vehicle operator performance (MIROP application), the MIROP application comprising:
identifying event information within data obtained from the one or more sensors, including:
detecting event information comprising: instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy;
comparing instances of host vehicle and/or remote vehicle hard braking, hard acceleration, and hard cornering to threshold acceleration, braking, and cornering values; and
periodically transmitting, via the I/O ports of the controller of one or more of the host vehicle and the I/O ports of the one or more remote vehicles, event information, relating to the instances of host vehicle and/or remote vehicle hard braking, hard acceleration and hard cornering that meet or exceed the threshold acceleration, braking, and cornering values, to the cloud computing server;
assessing a physical location and proximity of the host vehicle to remote vehicles participating in the method, including:
confirming a location of the host vehicle relative to map information stored in a map database;
determining a location of the one or more remote vehicles relative to map information stored in the map database; and
determining that one or more of the remote vehicles is at or below a threshold physical distance of the host vehicle, or that one or more of the remote vehicles has traversed a road segment at or within a threshold quantity of time relative to the host vehicle;
assessing a road surface condition of a road segment upon which the host vehicle is traveling, including:
utilizing data from the one or more sensors to estimate a road surface type, a road surface condition, a presence or absence of obstacles on the road segment, a location of lane markings on the road segment; and
obtaining information from one or more application programming interfaces (APIs) including a weather API, wherein the weather API provides weather information for the environment surrounding the host vehicle on the road segment;
estimating a traffic density on the road segment, including:
obtaining information from one or more application programming interfaces (APIs) including one or more traffic APIs, wherein the traffic APIs report, to the host vehicle, current and historical traffic information about the road segment; and
utilizing data from the traffic API and from the one or more sensors to estimate a traffic density including traffic signal status at approximately a one second accuracy, and that determines when the host vehicle is approaching or passing through a traffic signal;
aggregating host vehicle behavioral data and identifying event IDs within the host vehicle behavioral data, including:
identifying event IDs corresponding to instances of host vehicle and/or remote vehicle hard braking, hard acceleration, hard cornering, average speed, seat belt status, stability control status, frontal collision avoidance (FCA) activation, lane departure warning (LDW) activation, distance driven, clock time, and fuel economy;
determining when one or more remote vehicle perspectives is available, wherein upon determining that one or more remote vehicle perspectives is available utilizing the remote vehicle perspectives to provide context to behavior of the host vehicle; and
accessing a road profile database that includes physical characteristics of the road segment, and contextual information, including traffic data, time of day information, and road surface information relating to the road segment;
computing a vehicle operator insurability score, including:
calculating first order vehicle operator driving characteristics;
calculating a derived time series for vehicle operator driving parameters of interest; and
applying weighting factors to each to determine a relative performance of the vehicle operator in comparison with similarly-situated remote vehicle operators in similar contexts over the road segment or similar road segments;
calculating aggressiveness x(t), via sudden acceleration a(t) and close following distances b(t);
calculating an average aggressiveness according to:
$$( {p}_{1}^{i} ) : \overline{{x}_{ι}} = {\sum }_{t = 1}^{T} \frac{{x}_{i} ( t )}{T} ; \qquad II .$$
calculating a standard deviation in aggressiveness according to:
$$( {p}_{2}^{i} ) : \tilde{{x}_{ι}} = \sqrt{{\sum }_{t = 1}^{T} \frac{( {x}_{i} ( t ) - \overline{x} )}{T - 1}} ; \qquad III .$$
calculating a vehicle operator aggressiveness trend over time according to:
$$( {p}_{a}^{i} ) : \hat{{β}_{ι}} = \frac{{\sum }_{i = 0}^{n} ( {x}_{i} - \overline{x} ) ( {y}_{i} - \overline{y} )}{{\sum }_{i = 0}^{n} {( {x}_{i} - \tilde{x} )}^{2}} > 0 ; \qquad IV .$$
where (xᵢ−x̅)² is a normalizing characteristic, and \hat{β}_{ι} indicates whether the vehicle 12, 12′ operator is becoming more, less, or equally aggressive over a predefined quantity of time; and
calculating a cumulative distribution function (CDF) that ranks all participating host and remote vehicle operator performance according to:
$${\sum }_{i = 1}^{n} {w}_{i} * rank ( {a}_{1} , {Q}_{1} ) ; \qquad I .$$
where each aₙ defines a characteristic of a particular event Qₙ on a per-vehicle n basis, and wᵢ defines the weighting factors;
automatically notifying an insurance carrier of the vehicle operator insurability score, including: selectively notifying an insurance carrier of the vehicle operator insurability score based on one or more of: a predetermined time schedule, a quantity of distance traveled by the host vehicle operator, identified behavioral changes, host vehicle location changes, and host vehicle commute pattern changes; and
automatically presenting to a host vehicle operator, via a human-machine interface (HMI), score information and vehicle operation suggestions to improve the vehicle operator insurability score, including:
presenting the operator score information and vehicle operation suggestions on one or more of: an infotainment display of the host vehicle, an instrument cluster of the host vehicle, an interior rear-view screen of the host vehicle, a cellular device, a laptop computer, and a tablet computer, wherein the vehicle operation suggestions comprise: score improvement advice, driving behavior improvement suggestions, driving route modification suggestions, and host vehicle mode selection suggestions.
